(19) United States
(12) Patent Application Publication
(10) Pub. No.: US 2020/0231293 A1
(43) Pub. Date: Jul. 23, 2020

(54) DEDICATED CORE INFLOW INLET FOR CONVERTIBLE ENGINE

(71) Applicant: Bell Helicopter Textron Inc., Fort Worth, TX (US)

(72) Inventors: Thomas Dewey PARSONS, Fort Worth, TX (US); Alan Hisashi STEINERT, Fort Worth, TX (US)

(73) Assignee: Bell Helicopter Textron Inc., Fort Worth, TX (US)

(21) Appl. No.: 16/251,562

(22) Filed: Jan. 18, 2019

(51) Int. Cl. B64D 27/14; B64C 29/00; B64D 33/02

(52) U.S. Cl. CPC B64D 27/14; F02C 7/04; B64D 33/02; B64C 29/0033

(57) ABSTRACT

An exemplary convertible engine includes an engine housing forming a fan duct extending from a fan inlet to an exhaust; a fan positioned in the fan duct proximate the fan inlet; an engine core located in the fan duct aft of the fan, the engine core coupled to the fan by a fan shaft; a drive shaft mechanically coupled to the engine core and extending exterior of the engine housing; and a dedicated core inflow duct coupled to the core and having a core inlet to capture and direct air into the engine core. An inlet barrier filter may be located in the dedicated core inflow duct. The core inlet may be located inside of the fan duct or exterior to the fan duct. A gearbox may be operationally connected to the fan shaft and may be located inside of the fan duct.

### BACKGROUND

This section provides background information to facilitate a better understanding of the various aspects of the disclosure. It should be understood that the statements in this section of this document are to be read in this light, and not as admissions of prior art.

Fixed-wing aircraft, such as airplanes, are capable of flight using wings that generate lift responsive to the forward airspeed of the aircraft, which is generated by thrust from one or more jet engines or propellers. The wings generally have an airfoil cross-section that deflects air downward as the aircraft moves forward, generating the lift force to support the aircraft in flight. Fixed-wing aircraft, however, typically require a runway that is hundreds or thousands of feet long for takeoff and landing.

Unlike fixed-wing aircraft, vertical takeoff and landing (VTOL) aircraft do not require runways. Instead, VTOL aircraft are capable of taking off, hovering and landing vertically. One example of a VTOL aircraft is a helicopter which is a rotorcraft having one or more rotors that provide lift and thrust to the aircraft. The rotors not only enable hovering and vertical takeoff and landing, but also enable forward, backward and lateral flight. These attributes make helicopters highly versatile for use in congested, isolated or remote areas. Helicopters, however, typically lack the forward airspeed of fixed-wing aircraft due to the phenomena of retreating blade stall and advancing blade compression.

Tiltrotor aircraft attempt to overcome this drawback by utilizing proprotors that can change their plane of rotation based on the operation being performed. Tiltrotor aircraft typically have a pair of nacelles mounted near the outboard ends of a fixed wing with each nacelle housing a propulsion system that provides torque and rotational energy to a proprotor. The nacelles are pivotable relative to the fixed wing such that the proprotor blades have a generally horizontal plane of rotation providing vertical thrust for takeoff, hovering and landing, much like a conventional helicopter, and a generally vertical plane of rotation providing forward thrust for cruising in forward flight with the fixed wing providing lift, much like a conventional propeller driven airplane.

### SUMMARY

An exemplary turbine engine includes an engine housing forming a fan duct extending from a fan inlet to an exhaust, a fan positioned in the fan duct proximate the fan inlet, an engine core located in the fan duct aft of the fan, the engine core coupled to the fan by a fan shaft, and a dedicated core inflow duct coupled to the core and having a core inlet to capture and direct air into the engine core. An inlet barrier filter may be located in the dedicated core inflow duct. The core inlet may be located inside of the fan duct or exterior to the fan duct. A gearbox may be operationally connected to the fan shaft and may be located inside of the fan duct.

An exemplary convertible engine includes an engine housing forming a fan duct extending from a fan inlet to an exhaust, a fan positioned in the fan duct proximate the fan inlet, an engine core located in the fan duct aft of the fan, the engine core coupled to the fan by a fan shaft, a drive shaft mechanically coupled to the engine core and extending exterior of the engine housing, and a dedicated core inflow duct coupled to the core and having a core inlet to capture and direct air into the engine core. An inlet barrier filter may be located in the dedicated core inflow duct. The core inlet may be located inside of the fan duct or exterior to the fan duct. A gearbox may be operationally connected to the fan shaft and may be located inside of the fan duct.

An exemplary tiltrotor aircraft includes a fuselage having a wing and a tail; two proprotors connected to the wing and pivotable between a vertical takeoff and landing (VTOL) position and a forward flight position, a convertible engine mounted with the fuselage and including an engine housing forming a fan duct extending from a fan inlet to an exhaust, a fan positioned in the fan duct proximate the fan inlet, an engine core located in the fan duct aft of the fan, the engine core coupled to the fan by a fan shaft, a drive shaft mechanically coupled to the engine core and operationally connected to the proprotors, and a dedicated core inflow duct coupled to the core and having a core inlet to capture and direct air into the engine core. An inlet barrier filter may be located in the dedicated core inflow duct. The core inlet may be located inside of the fan duct or exterior to the fan duct. A gearbox may be operationally connected to the fan shaft and may be located inside of the fan duct. The convertible engine may be operable to provide shaft horsepower through the drive shaft to rotate the proprotors or provide power to the fan to create forward thrust.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIGS. 1-4 are schematic illustrations of an exemplary tiltrotor aircraft in various flight modes in accordance with embodiments of the present disclosure.

FIG. 5 is a schematic illustration of an exemplary turbine engine incorporating a dedicated core inflow inlet.

FIG. 6 is a schematic illustration of another exemplary turbine engine incorporating a dedicated core inflow inlet.

FIG. 7 is a schematic illustration of another exemplary turbine engine incorporating a dedicated core inflow inlet.

FIG. 8 is a schematic illustration of an exemplary tiltrotor aircraft incorporating a convertible engine with a dedicated core inflow inlet.

FIG. 9 is a schematic illustration of an exemplary tiltrotor aircraft incorporating a convertible engine with a dedicated core inflow inlet in a hybrid propulsion drive train.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

Helicopters are incredibly useful aircraft allowing for vertical takeoff, hovering and vertical landing. However, helicopter speed and range performance falls far short of that provided by conventional fixed-wing airplanes. The development of tiltrotor technology has increased the speed of rotorcraft to over 300 MPH (482 KPH) and extended range to approach the performance of conventional turboprop aircraft. Tiltrotor speed performance still falls short of what can be achieved by conventional jet propulsion aircraft.

Jet fighter/attack aircraft such as the AV-8B Harrier and F-35 Lightning utilize jet thrust to provide vertical takeoff, hovering and vertical landing, and can obtain speeds of over 600 MPH (965 KPH). However, the penalty for using jet thrust to provide vertical lift is dramatically reduced useful payload and range performance. Reduced payload and range performance is a direct consequence of the high disc loading (projected area of lift thrust) when using jet thrust to provide vertical lift. The relatively low disc loading of helicopters and tiltrotors allows for efficient vertical lift.

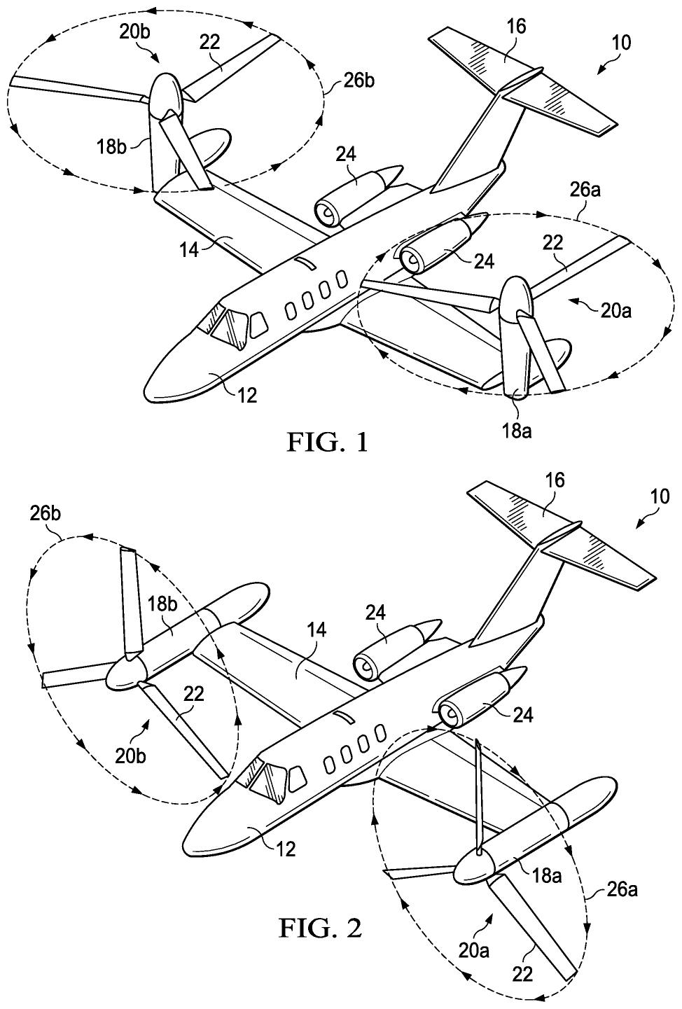

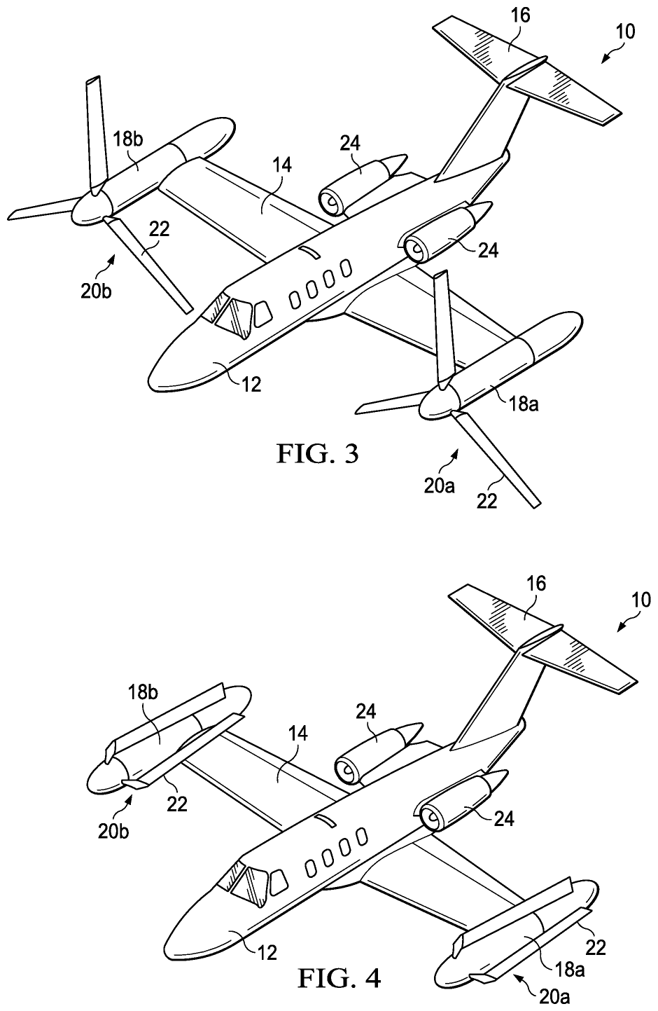

Referring to FIGS. 1-4, a tiltrotor aircraft is schematically illustrated and generally designated 10. Aircraft 10 includes a fuselage 12, a wing 14 and a tail assembly 16 including control surfaces operable for horizontal and/or vertical stabilization during forward flight. Located proximate the outboard ends of wing 14 are pylons or nacelles 18a, 18b that are rotatable relative to wing 14 between a generally vertical orientation, as best seen in FIG. 1, and a generally horizontal orientation, as best seen in FIGS. 2-4. Nacelles 18a, 18b may house a portion of the drive system that rotates proprotor assemblies 20a, 20b, respectively. Each proprotor assembly 20a, 20b includes a plurality of proprotor blades 22 that are operable to rotate, as best seen in FIGS. 1-2. In some embodiments, proprotor blades 22 are operable to be feathered, as best seen in FIG. 3 and operable to be folded, as best seen in FIG. 4. Aircraft 10 includes one or more convertible engines 24 that can operate in turboshaft mode, turbofan mode, or a combination of turbo shaft and turbofan mode.

FIG. 1 illustrates aircraft 10 in VTOL or helicopter flight mode, in which proprotor assemblies 20a, 20b are rotating in a substantially horizontal plane to provide a lifting thrust, such that aircraft 10 flies much like a conventional helicopter. In this configuration, convertible engines 24 are operable in turboshaft mode where hot combustion gases in each engine core cause rotation of a turbine that is operationally connected to proprotor assemblies 20a, 20b. Thus, in this configuration, aircraft 10 is considered to be in a rotary flight mode.

FIG. 2 illustrates aircraft 10 in proprotor forward flight mode, in which proprotor assemblies 20a, 20b are rotating in a substantially vertical plane to provide a forward thrust enabling wing 14 to provide a lifting force responsive to forward airspeed, such that aircraft 10 flies much like a conventional propeller driven aircraft. In this configuration, convertible engines 24 are operable in the turboshaft mode and aircraft 10 is considered to be in the rotary flight mode.

In the rotary flight mode of aircraft 10, proprotor assemblies 20a, 20b rotate in opposite directions to provide torque balancing to aircraft 10. For example, when viewed from the front of aircraft 10 in proprotor forward flight mode (FIG. 2) or from the top in helicopter mode (FIG. 1), proprotor assembly 20a rotates clockwise, as indicated by motion arrows 26a, and proprotor assembly 20b rotates counterclockwise, as indicated by motion arrows 26b. In the illustrated embodiment, proprotor assemblies 20a, 20b each includes three proprotor blades 22 that are equally spaced apart circumferentially at approximately 120-degree intervals. It should be understood by those having ordinary skill in the art, however, that the proprotor assemblies of the present disclosure could have proprotor blades with other designs and other configurations including proprotor assemblies having four, five or more proprotor blades. In addition, it should be appreciated that aircraft 10 can be operated such that proprotor assemblies 20a, 20b are selectively positioned between proprotor forward flight mode and helicopter mode, which can be referred to as a conversion flight mode.

FIG. 3 illustrates aircraft 10 in transition between proprotor forward flight mode and airplane forward flight mode, in which proprotor blades 22 of proprotor assemblies 20a, 20b have been feathered, or oriented to be streamlined in the direction of flight, such that proprotor blades 22 act as brakes to aerodynamically stop the rotation of proprotor assemblies 20a, 20b. In this configuration, as the proprotor slows down, the convertible engines 24 transition to turbofan mode where hot combustion gases in each core cause rotation of a turbine that is mechanically coupled to a fan that forces bypass air through a fan duct to create forward thrust enabling wing 14 to provide a lifting force responsive to forward airspeed, such that aircraft 10 flies much like a conventional jet aircraft. Thus, in this configuration, aircraft 10 is considered to be in a non-rotary flight mode. As further described below, convertible engine 24 can provide simultaneous power to create forward fan thrust and shaft horsepower.

FIG. 4 illustrates aircraft 10 in airplane forward flight mode, in which proprotor blades 22 of proprotor assemblies 20a, 20b have been folded to be oriented substantially parallel to respective nacelles 18a, 18b to minimize the drag force generated by proprotor blades 22. In this configuration, convertible engines 24 are operable in the turbofan mode and aircraft 10 is considered to be in the non-rotary flight mode. The forward cruising speed of aircraft 10 can be significantly higher in airplane forward flight mode versus proprotor forward flight mode as the forward airspeed induced proprotor aeroelastic instability is overcome.

Even though aircraft 10 is illustrated as having two engines fixed to the fuselage, it should be understood by those having ordinary skill in the art that other engine arrangements are possible and are considered to be within the scope of the present disclosure. In addition, even though proprotor assemblies 20a, 20b are illustrated in the context of tiltrotor aircraft 10, it should be understood by those having ordinary skill in the art that the proprotor assemblies disclosed herein can be implemented on other tiltrotor aircraft including, for example, quad tiltrotor aircraft having an additional wing member aft of wing 14, unmanned tiltrotor aircraft or other tiltrotor aircraft configurations.

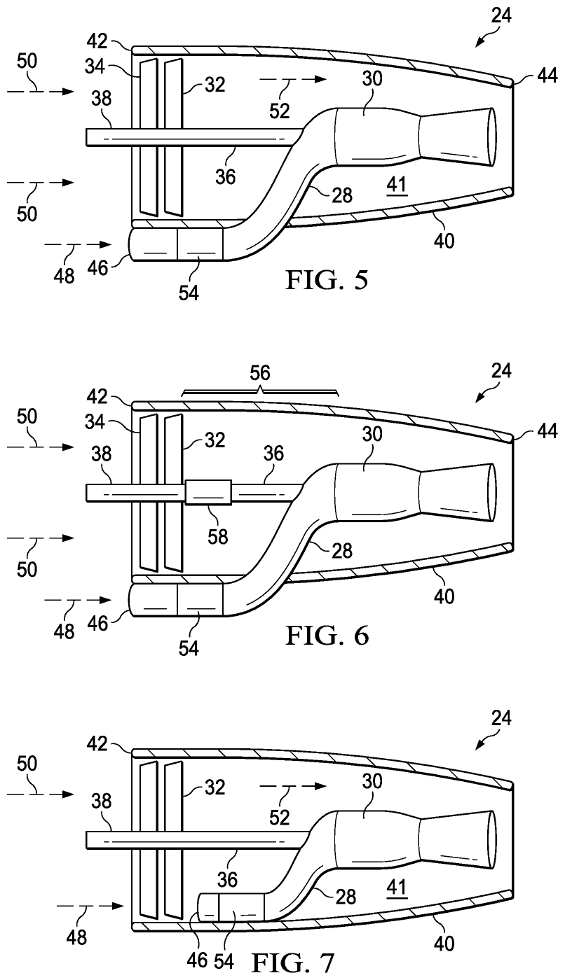

FIG. 5 schematically illustrates an exemplary convertible engine 24 incorporating a dedicated core inflow duct 28. Convertible engine 24 is a turbine engine including a core 30 (e.g., compressor, burner, and turbine) mechanically coupled to a ducted fan 32 and inlet guide vanes 34. Fan 32 is positioned forward of core 30 and mechanically coupled to core 30 by a fan shaft 36. In a convertible engine configuration, core 30 is coupled to a drive shaft 38 for operational connection with one or more of the proprotors or to another aircraft system. Convertible engine 24 may be configured to provide substantially shaft horsepower only, substantially fan thrust only, and multi-mode simultaneous power sharing.

Fan 32 and core 30 are positioned inside of a duct 41 that is provided by an engine housing 40. Engine housing 40 and fan duct 41 extend from a forward-facing fan inlet 42 to an exhaust 44. Exhaust 44 may include a variable area nozzle. As will be understood by those skilled in the art with benefit of this disclosure, convertible engine 24 may be configured from a conventional turbofan engine or may be configured by combining a turboshaft engine with a fan assembly.

Core inflow duct 28 extends from a forward-facing core inlet 46 to core 30. Core inlet 46 captures incoming air, referred to as core inflow 48, and directs it into core 30 where it is mixed with fuel and combusted. In the FIG. 5 embodiment, core inlet 46 is independent of fan inlet 42 and is located exterior of engine housing 40 that forms the duct for fan 32. Core inlet 46 may be routed to a location on the aircraft to capture high-pressure airflow.

In this embodiment, the total airflow 50 that is captured by fan inlet 42 bypasses core 30 and is referred to as bypass flow 52. Forward thrust is produced from the core exhaust and from bypass flow 52. The thrust produced by bypass flow 52 may be controlled by adjusting inlet guide vanes 34. For example, in turboshaft mode, inlet guide vanes 34 may close fan 32 so that forward turbofan thrust is not produced by fan 32 or is minimally produced and core power is directed to drive shaft 38. In some embodiments, fan 32 may be declutched from core 30 increasing the shaft horsepower available from core 30 in turboshaft mode to drive the proprotors.

An inlet barrier filter 54 is positioned in core inflow duct 28. Core inflow duct 28 and/or the incorporation of inlet barrier filter 54 may simplify ice protection of the core inlet and eliminate the electro-thermal heating systems required in conventional turbofan-type engine arrangements. As will be understood by those skilled in the art with the benefit of this disclosure, dedicated core inflow duct 28 simplifies the engine core flow air filtration requirements. Less air mass flow to inlet barrier filter 54, thus less filter area required than in a convention turbofan-type engine arrangement.

FIG. 6 schematically illustrates another exemplary convertible engine 24 incorporating a dedicated core inflow duct 28. In a conventional turbofan engine, the fan and core are positioned too close together to position an inlet barrier filter or to install a core inflow duct. A sufficient distance 56 must be established between core 30 and fan 32 to locate core inflow duct 28. Convertible engine 24 may be constructed to have a sufficient distance 56 by coupling a fan assembly to a turboshaft engine. With the increased distance 56 available, relative to a conventional turbofan engine, a gearbox 58 may be coupled with fan shaft 36 and/or drive shaft 38. Gearbox 58 may facilitate, for example, declutching fan 32 to direct more of the core power to drive shaft 38 for example during rotary flight. Gearbox 58 may allow adjusting the speed (RPM) of fan 32 to optimize forward fan thrust and shaft power during various flight modes, including conversion flight mode and transition from rotary to non-rotary flight.

FIG. 7 is a schematic illustration of another exemplary convertible engine 24 incorporating a dedicated core inflow duct 28. In this embodiment, core inlet 46 is positioned inside of duct 41 to capture core inflow 48 from a portion of total airflow 50 entering fan inlet 42. Core inlet 46 is a dedicated to only providing inflow to core 30.

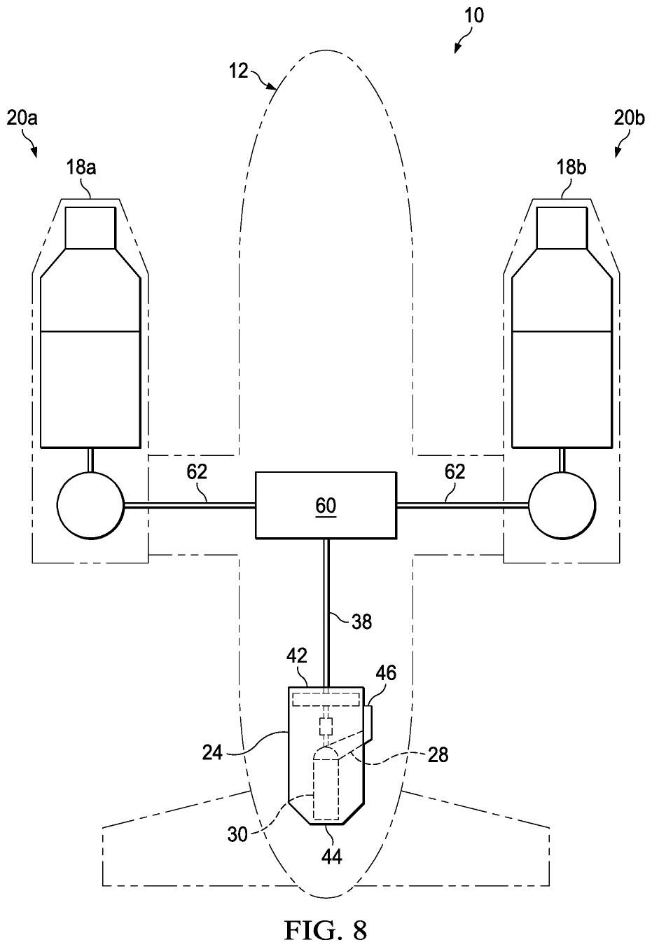

FIG. 8 schematically illustrates an exemplary tiltrotor aircraft 10 with a convertible engine 24. Convertible engine 24 is mounted with fuselage 12. Convertible engine 24 incorporates a dedicated core inflow duct 28 as described with reference to FIGS. 5-7. Convertible engine 24 is operationally connected to proprotor assemblies 20a, 20b located respectively with nacelles 18a, 18b. In this embodiment, drive shaft 38 mechanically couples core 30 to a central gearbox 60 that is mechanically coupled to proprotor assemblies 20a, 20b via output shafts 62.

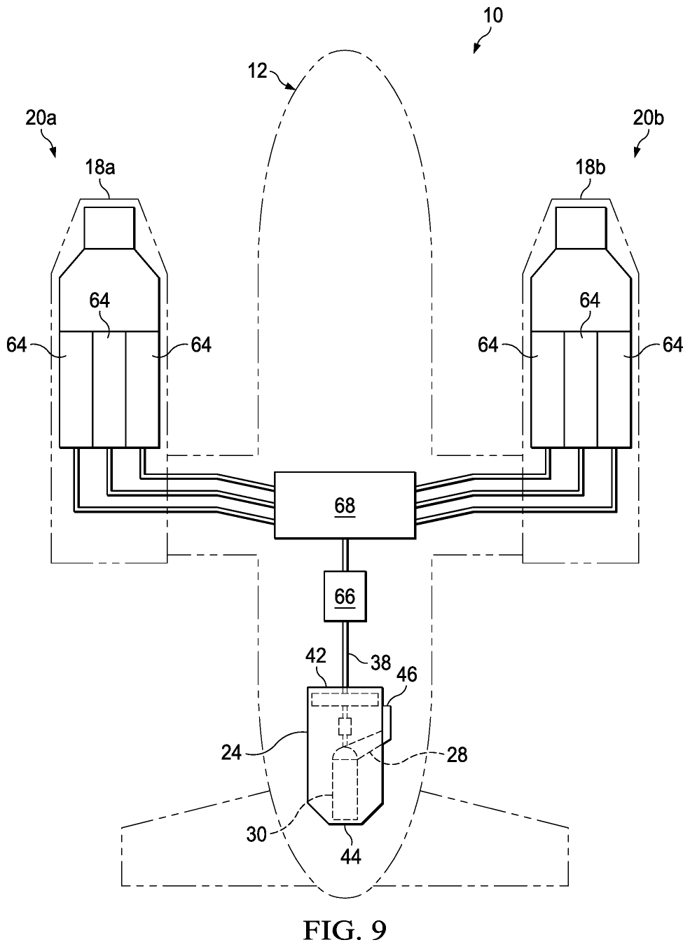

FIG. 9 schematically illustrates another exemplary tiltrotor aircraft 10 using a convertible engine 24. Convertible engine 24 is mounted with fuselage 12. Convertible engine 24 incorporates a dedicated core inflow duct 28 as described for example with reference to FIGS. 5-7. Convertible engine 24 is operationally connected to proprotor assemblies 20a, 20b located respectively with nacelles 18a, 18b. In the embodiment, tiltrotor aircraft 10 incorporates a hybrid propulsion system. Each proprotor assembly 20a, 20b is coupled to one or more electric motors 64. Drive shaft 38 mechanically couples core 30 to an electric generator 66 that is electrically connected to motors 64 via an electrical bus 68. Shaft horsepower can be directed from core 30 to generator 66 to produce electricity and power motors 64 and rotate proprotor assemblies 20a, 20b.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard, “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A turbine engine, comprising:
an engine housing forming a fan duct extending from a fan inlet to an exhaust;
a fan positioned in the fan duct proximate the fan inlet;
an engine core located in the fan duct aft of the fan, the engine core coupled to the fan by a fan shaft; and
a dedicated core inflow duct coupled to the core and having a core inlet to capture and direct air into the engine core.

2. The turbine engine of claim 1, further comprising a filter located in the dedicated core inflow duct.

3. The turbine engine of claim 1, wherein the core inlet is located inside the fan duct.

4. The turbine engine of claim 1, wherein the core inlet is located exterior of the fan duct.

5. The turbine engine of claim 1, wherein the core inlet is located exterior of the fan duct and exterior of the engine housing.

6. The turbine engine of claim 1, further comprising a gearbox operationally connected to the fan shaft and located in the fan duct.

7. The turbine engine of claim 6, further comprising a filter located in the dedicated core inflow duct.

8. A convertible engine, comprising:
an engine housing forming a fan duct extending from a fan inlet to an exhaust;
a fan positioned in the fan duct proximate the fan inlet;
an engine core located in the fan duct aft of the fan, the engine core coupled to the fan by a fan shaft;
a drive shaft mechanically coupled to the engine core and extending exterior of the engine housing; and
a dedicated core inflow duct coupled to the core and having a core inlet to capture and direct air into the engine core.

9. The convertible engine of claim 8, further comprising a filter located in the dedicated core inflow duct.

10. The convertible engine of claim 8, wherein the core inlet is located inside the fan duct.

11. The convertible engine of claim 8, wherein the core inlet is located exterior of the fan duct.

12. The convertible engine of claim 8, further comprising a gearbox operationally connected to the fan shaft and located in the fan duct.

13. The convertible engine of claim 12, further comprising a filter located in the dedicated core inflow duct.

14. A tiltrotor aircraft, comprising:
a fuselage having a wing and a tail;
two proprotors connected to the wing and pivotable between a vertical takeoff and landing (VTOL) position and a forward flight position;
a convertible engine mounted with the fuselage, the convertible engine comprising:
an engine housing forming a fan duct extending from a fan inlet to an exhaust;
a fan positioned in the fan duct proximate the fan inlet;
an engine core located in the fan duct aft of the fan, the engine core coupled to the fan by a fan shaft;
a drive shaft mechanically coupled to the engine core and operationally connected to the proprotors; and
a dedicated core inflow duct coupled to the core and having a core inlet to capture and direct air into the engine core.

15. The tiltrotor aircraft of claim 14, further comprising a filter located in the dedicated core inflow duct.

16. The tiltrotor aircraft of claim 14, wherein the core inlet is located inside the fan duct.

17. The tiltrotor aircraft of claim 14, wherein the core inlet is located exterior of the fan duct.

18. The tiltrotor aircraft of claim 14, further comprising a gearbox operationally connected to the fan shaft and located in the fan duct.

19. The tiltrotor aircraft of claim 18, further comprising a filter located in the dedicated core inflow duct.

20. The tiltrotor aircraft of claim 19, wherein the core inlet is located exterior of the fan duct.
